(19) United States
(12) Patent Application Publication
(10) Pub. No.: US 2012/0141777 A1
(43) Pub. Date: Jun. 7, 2012

(54) LAMINATE COMPOSED OF CERAMIC INSULATING LAYER AND METAL LAYER, AND METHOD FOR PRODUCING THE SAME

(75) Inventors: Yasushi Idemoto, Noda-shi (JP); Ryuichi Sato, Ageo-shi (JP); Naohiko Abe, Ageo-shi (JP)

(73) Assignee: MITSUI MINING & SMELTING CO., LTD., Tokyo (JP)

(21) Appl. No.: 13/375,296

(22) PCT Filed: Apr. 20, 2010
(86) PCT No.: PCT/JP2010/056968

§ 371 Date: Feb. 13, 2012

(30) Foreign Application Priority Data
Jun. 4, 2009 (JP) 2009-134927

(51) Int. Cl. B32B 18/00; C25D 13/02; B05D 3/02; B32B 15/04

(52) U.S. Cl. 428/325; 428/457; 428/336; 204/487; 204/488

(57) ABSTRACT

The object of the present invention is to provide a metal layer with an insulating layer which is uniform and thin and can be produced in low cost. To achieve the object, a laminate composed of a ceramic insulating layer and a metal layer characterized in that the ceramic insulating layer has a binder provided among ceramic particles constituting a ceramic particle film formed by electrophoretic deposition of the ceramic particles is employed. The laminate can be suitably used as a base material for production of various types of electronic devices, the circuit formation of printed wiring boards, semiconductor circuits and circuits including semiconductor circuits, and capacitors utilizing dielectric performance of the ceramic insulating layer.

### TECHNICAL FIELD

The present invention relates to a laminate composed of a ceramic insulating layer and a metal layer, and a method for producing the laminate composed of a ceramic insulating layer and a metal layer. In particular, the laminate composed of a ceramic insulating layer and a metal layer is a material suitably used in production of various types of electronic devices, the circuit formation of printed wiring boards, semiconductor circuits and circuits including semiconductor circuits, and capacitors utilizing dielectric performance of the ceramic insulating layer and the like.

### BACKGROUND ART

A metal foil provided with an insulating layer or a dielectric material layer is used as a base material for printed wiring boards and the like constituting an electronic device circuit. Hereinafter, an insulating layer or a dielectric material layer is simply referred to as “an insulating layer”, and a metal foil provided with the insulating layer is simply referred to as “a metal foil with an insulating layer”. The production method of the insulating layer includes a composite type and a binder-less type. In the composite type, ceramic particles dispersed in a resin binder are coated on a metal foil and cured. In the binder-less type, a layer of a ceramics formed on a metal layer by a sol-gel method, a sputter method, a CVD method or the like are finished in a production process.

First, features of the composite type are as followings. The properties to be achieved can be adjusted by controlling the ratio between the ceramic particles and the binder resin. In addition, a property of the insulating layer makes leakage current small and it may make insulating performance of provided insulating layer excellent easily because the resin is provided as a binder. Further, production process can be made relatively simple with high productivity. Next, the composite type is suitable for forming a relatively thick insulating layer. The composite type is disclosed in Patent Document 1 and the like.

Next, in the binder-less type, it is popular to add an element other than a main component to improve the insulating performance and the like. According to the production method, the leakage current is reduced by a core-shell structure formed by deposition of the additional element in the grain boundary of the main component in annealing step. The binder-less type is excellent in the viewpoint for providing uniform and thin insulating layer. The binder-less type is disclosed in Patent Document 2 and the like.

### DOCUMENT CITED

### Patent Document

[Patent Document 1] Japanese Patent Laid-Open No. 2003-292733
[Patent Document 2] Japanese Patent Laid-Open No. 2006-196848

### SUMMARY OF THE INVENTION

### Problems to be Solved

However, in the composite type, it is difficult to provide an insulating layer having a thickness of 5 μm or less. In addition, uniform coating on a metal foil is made difficult when the content ratio of ceramic particles is intended to be big.

On the other hand in the binder-less type, when an insulating layer is formed by a sol-gel method, plural times of coating should be carried out to adjust a film thickness in a specific range. In addition, the method is not preferable because a heating process at a high temperature is required and it may cause the deterioration of a metal substrate. Next, when an insulating layer is formed by a sputtering method, a large-size vacuum apparatus is required and it limits price reduction of the product.

As can be understood from the descriptions above, a metal layer provided with an insulating layer uniform and thin but production can be performed in low cost has been demanded.

### Means to Solve the Problem

As a result of concentrated studies of the present inventors, the matter that both mechanical and electrical properties are caught up when the process in which an insulating layer made of just particles having a ceramic structure is first formed and then a binder is impregnated is applied was thought out. That is, when the ceramic insulating layer is formed by electrophoretic deposition or the like and then a resin or the like is impregnated, a composite film almost as thin as those formed by a sol-gel method can be produced in a short time with lower cost. In addition, in comparison with the composite type, the method can drastically improve the packing density of ceramic particles included in the insulating layer.

### <Laminate Composed of a Ceramic Insulating Layer and a Metal Layer>

The laminate composed of a ceramic insulating layer and a metal layer according to the present invention is a laminate composed of a ceramic insulating layer and a metal layer, wherein the ceramic insulating layer includes a binder provided among ceramic particles constituting a ceramic particle film formed by electrophoretic deposition of the ceramic particles. In addition, the laminate composed of a ceramic insulating layer and a metal layer includes the following two types. They are referred to as “Type I” and “Type II”, and will be demonstrated separately.

Type I: The laminate composed of a ceramic insulating layer and a metal layer of Type I according to the present invention is the metal layer with an insulating layer in which a ceramic insulating layer is provided on the metal layer surface characterized in that the insulating layer has a ceramic binder provided among ceramic particles.
Type II: The laminate composed of a ceramic insulating layer and a metal layer of Type II according to the present invention is the metal layer with an insulating layer in which the ceramic insulating layer is provided on the metal layer surface characterized in that the insulating layer has a resin binder provided among ceramic particles.

### <Methods for Producing a Laminate Composed of a Ceramic Insulating Layer and a Metal Layer>

With regard to the methods for producing a laminate composed of a ceramic insulating layer and a metal layer according to the present invention, a production method for Type I will be referred to as “the first production method”; and a production method for Type II will be referred to as “the second production method”, and these methods will be demonstrated separately according to Types.

The first production method: the production method of a laminate composed of a ceramic insulating layer and a metal layer of Type I described above is characterized in that a ceramic particle film is formed on a surface of a metal layer; a precursor solution which is able to be a ceramic is impregnated among ceramic particles constituting the ceramic particle film; and then heat treatment is carried out to convert the impregnated precursor solution into the ceramics. In this way, the insulating layer in which a ceramic binder is provided among the ceramic particles is finished.
The second production method: the production method of a laminate composed of a ceramic insulating layer and a metal layer of Type II is characterized in that a ceramic particle film is formed on a surface of a metal layer; a resin varnish is impregnated among ceramic particles constituting the ceramic particle film; and then heat treatment is carried out to make the impregnated resin varnish semi-cure or cure. In this way, the insulating layer in which a resin binder is provided among the ceramic particles is finished.

### <Various Types of Products Using a Laminate Composed of a Ceramic Insulating Layer and a Metal Layer>

The laminate composed of a ceramic insulating layer and a metal layer according to the present invention can be suitably used in production of various types of electronic devices, the circuit formation of printed wiring boards, semiconductor circuits and circuits including semiconductor circuits, and capacitors utilizing dielectric performance of the ceramic insulating layer and the like.

### Advantages of the Invention

In the laminate composed of a ceramic insulating layer and a metal layer according to the present invention, materials for both “ceramic particles” and “a binder provided among ceramic particles” constituting the ceramic insulating layer can be selected free. As a result, the ceramic insulating layer can be adjusted in wide range of electric properties, from high insulating materials to dielectric materials in response to the applications. With proper combination of the material and the amount of the binder to be impregnated, the laminate can be a rigid electronic materials or a flexible electronic materials used in the field of electronic devices.

The production methods of the laminate composed of a ceramic insulating layer and a metal layer are the method in which ceramic particles are deposited on a metal layer surface by an electrophoretic deposition to form a ceramic particle film on the metal layer surface, a precursor solution which is able to be a ceramic or a resin varnish is impregnated among ceramic particles constituting the ceramic particle film, and then heat treatment is carried out. In this way, a binder is provided among the ceramic particles constituting the ceramic particle film and an insulating layer is finished. Therefore, the ceramic insulating layer is excellent in the film thickness reduction when compared to the case where an insulating layer is formed by the conventional composite method.

### DETAILED DESCRIPTION OF THE INVENTION

Hereinafter, embodiments of the laminate composed of a ceramic insulating layer and a metal layer according to the present invention, production method of the laminate composed of a ceramic insulating layer and a metal layer, and various types of products using the laminate composed of a ceramic insulating layer and a metal layer, will be demonstrated.

### A: Embodiment of the Laminate Composed of a Ceramic Insulating Layer and a Metal Layer

The laminate composed of a ceramic insulating layer and a metal layer according to the present invention includes the following two types, Type I and Type II, and will be demonstrated separately.

### <Embodiment of Type I>

The laminate composed of a ceramic insulating layer and a metal layer of Type I according to the present invention is a laminate composed of a ceramic insulating layer and a metal layer. In the Type I, the ceramic insulating layer is characterized in being provided with a ceramic binder among ceramic particles. Next, constituting elements, “the ceramic particles” and “the ceramic binder” will be demonstrated.

Metal layer: The metal layer may be a metal layer formed by any method. For example, when a metal foil is used for formation of the metal layer, all of metal foils including copper foils produced by a rolling method, an electrolysis method and the like, nickel foils, copper alloy foils (brass foils, Corson alloy foils) and nickel alloy foils (nickel-phosphorus alloy foils, nickel-cobalt alloy foils and the like) or the like can be used. In addition, the foils such as a composite foil in which a different kind of a metal layer is provided on surface of the metal foil are also included. For example, a composite foil may be the foil in which a nickel layer or a nickel alloy layer is provided on the surface of a copper foil. Further a composite material in which a metal layer is provided on the surface of a resin film or the like may be used. The composite material in which a metal layer is provided on the surface of a resin film or the like is obtained by laminating a metal foil on the surface of a resin film or the like, or forming a metal layer on the surface of a resin film or the like by a physical vapor-deposition method. However, when it is considered that the metal layer will be subjected to an etching process, it is preferable to use a metal layer of single composition. This is because that formation of the fine circuits is made possible.
Ceramic particles: The ceramic particles used are the material to be electrodeposited on the surface of a metal layer by an electrophoretic deposition method for forming a ceramic particle film, and it is preferable to use particles having an average particle size of 300 nm or less. When the average particle size exceeds 300 nm, the impregnation treatment may hardly make the surface smooth because surface of an insulating layer after electrophoretic deposition is too rough. The lower limit of the average particle size is about 5 nm. When the average particle size is made less than 5 nm, particle aggregation becomes remarkable to make dealing of the particles difficult and tends to make film quality of the insulating layer ununiform. So, it is preferable to use ceramic particles having an average particle size of 10 nm to 120 nm. The average particle size disclosed in the present application is an average of particle sizes investigated by using a transmission electron microscope.

As for the ceramic particles, alumina particles, zirconia particles, titanate particles, zincate particles and the like can be selectively used in response to application of the laminate composed of a ceramic insulating layer and a metal layer. In addition, when dielectric performance is required for the oxide ceramic insulating layer, it is preferable to use dielectric particles having perovskite-type structure as the ceramic particles. The basic compositions of the particles having perovskite-type structure able to be exemplified are barium titanate, strontium titanate, barium strontium titanate, strontium zirconate, bismuth zirconate and the like. Especially among these, the material comprising a basic composition of barium titanate, strontium titanate or barium strontium titanate is more preferable.

Ceramic binder: In the laminate composed of a ceramic insulating layer and a metal layer according to the present invention, after the ceramic particle film described above is formed, a binder is provided among the particles. A ceramic binder applied in Type I is a material formed through impregnation of a precursor solution such as a sol-gel solution which is able to be a ceramics by post-heating into the ceramic particle film and heat treatment. By the way, a ceramic binder impregnated into a ceramic particle film may form a thin ceramic binder layer on a surface of the ceramic particle film. However, the binder layer does not cause drawback because the performance of an insulating layer or a dielectric layer is not remarkably deteriorated and synergistic effect to make the surface of the ceramic particle film smooth is obtained.

### <Type II>

The laminate composed of a ceramic insulating layer and a metal layer of Type II according to the present invention is the metal layer with an insulating layer in which a ceramic insulating layer is provided on the surface of a metal layer, as well as Type I. Type II is different from Type I in characteristic that the (ceramic) insulating layer is a ceramic insulating layer including a resin binder provided among ceramic particles. Therefore, just “a resin binder” will be demonstrated.

Resin binder: Resin binder applied in Type II is a material formed through impregnation of a resin varnish which is able to be semi-cured resin or cured resin by post-heating into the ceramic particle film and heat treatment. By the way, a resin binder impregnated into a ceramic particle film may form a thin resin binder layer on a surface of the ceramic particle film. However, the binder layer does not cause drawback because the performance of an insulating layer or a dielectric layer is not remarkably deteriorated and synergistic effect to make the surface of the ceramic particle film smooth is obtained.

### <Other Properties Common in Both Type I and Type II>

Other properties common in the laminate composed of a ceramic insulating layer and a metal layer of Type I and Type II shown above will be demonstrated.

Thickness of a ceramic insulating layer: The ceramic insulating layer of the laminate composed of a ceramic insulating layer and a metal layer of Type I and Type II described above is preferable to be a thickness of 0.1 μm to 5 μm, and more preferably a thickness of 2 μm or less. The laminate composed of a ceramic insulating layer and a metal layer of Type I and Type II can be produced continuously by a production method described later when a rolled metal foil is used. In the continuous production, product is preferable to be a wound roll from the viewpoint of the productivity and the production cost. It means that even when the product is wound up in a roll form, a risk that generation of a micro-crack in a ceramic insulating layer of the laminate composed of the ceramic insulating layer and a metal layer should be avoided. From such a point of view, it is preferable to make thickness of the ceramic insulating layer of the laminate composed of a ceramic insulating layer and a metal layer of Type I and Type II to be 5 μm or less because production of products in a roll form is made easy. In addition, thinner the thickness of the ceramic insulating layer, a generation risk of a micro-crack in the ceramic insulating layer is made gradually decreases.

### B: Embodiment of Production Method of a Laminate Composed of a Ceramic Insulating Layer and a Metal Layer

Hereinafter, a first production method for Type I and a second production method for Type II will be demonstrated separately.

With regard to the electrophoretic deposition method in the production method of a laminate composed of a ceramic insulating layer and a metal layer according to the present invention, a slurry containing ceramic particles (hereinafter, simply referred to as “ceramic particle slurry”) is prepared and electrophoresis of the ceramic particles in the slurry is carried out to make the ceramic particles deposit on a surface of a metal layer. In such a way, a ceramic particle film is formed on the metal layer surface in both the first production method and the second production method.

Embodiment of production of a ceramic binder in the first production method: The ceramic binder is formed through impregnation of a precursor solution which is able to be a ceramics among ceramic particles constituting a ceramic particle film formed by the electrophoretic deposition on a metal layer surface and heat-treatment carried out to converted the impregnated precursor solution into the ceramics. As a practical step included in the first production method, either process of the following “Process 1-1” or “Process 1-2” can be employed.
Process 1-1: A process 1-1 carries out following steps sequentially, “electro deposition of ceramic particles on a metal layer surface (formation of a ceramic particle film)”, “impregnation of a precursor solution for forming of a ceramic binder” and “heat treatment”.
Process 1-2: A process 1-2 carries out following steps sequentially, “electro deposition of ceramic particles on a metal layer surface (formation of a ceramic particle film)”, “pre-heat treatment”, “impregnation of a precursor solution for forming of a ceramic binder” and “heat treatment”.

The pre-heat treatment and the heat treatment are preferable to be carried out in the temperature range of 200° C. to 900° C.

The precursor solution used is not especially limited as long as being a precursor solution which is able to be a ceramics by post-heating. The precursor solution may be suitably and selectively used in response to the applications and the required properties. For example, a commercially available sol-gel solutions and the like that can be used for formation of a dielectric material are applicable.

To impregnate the precursor solution among ceramic particles constituting a ceramic particle film, any method which can bring a ceramic particle film formed on a metal layer surface into contact with a precursor solution as a result may be used. For example, a method in which a metal layer provided with a ceramic particle film formed thereon is immersed in a precursor solution and a method in which a precursor solution is sprayed on a ceramic particle film formed on a metal layer surface or the like may be used.

Embodiment of production method of a resin binder in the second production method: The resin binder is formed through impregnation of a resin varnish among ceramic particles constituting a ceramic particle film formed by the electrophoretic deposition on a metal layer surface and heat treatment for making the impregnated resin varnish semi-cured or cured. As a practical step included in the second production method, either process of the following “Process 2-1” or “Process 2-2” can be employed.
Process 2-1: A process 2-1 carries out following steps sequentially, “electro deposition of ceramic particles on a metal layer surface (formation of a ceramic particle film)”, “impregnation of a resin varnish for formation of a resin binder” and “heat treatment”.
Process 2-2: A process 2-2 carries out following steps sequentially, “electro deposition of ceramic particles on a metal layer surface (formation of a ceramic particle film)”, “pre-heat treatment”, “impregnation of a resin varnish for formation of a resin binder” and “heat treatment”.

The heat treatment will be demonstrated in detail later. However, the pre-heat treatment in the step of “Process 2-2” is preferable to be carried out at a temperature in the range of 200° C. to 900° C.

As for the resin varnish in the present invention, a commercially available thermosetting resin dissolved or dispersed in water or an organic solvent can be used. As for the thermosetting resins, various types of resins commercially available as an industrial product may be applicable, and are not especially limited. However, resins which do not generate volatile substances such as water and formaldehyde as vice-generative production in curing are suitable. Epoxy resins, urethane resins, unsaturated polyester resins, diallyl phthalate resins, acrylate resins, epoxy (metha) acrylate resins, urethane acrylate resins, maleimide resins and cyanate ester resins can be exemplified. These thermosetting resins may be used alone or as a mixture of two or more. In general, these resins are used by adding specific amounts of a curing agent and a curing accelerator according to the corresponding resins. So in the present invention, a curing agent and a curing accelerator can be added when required. Then, curing time can be adjusted.

As a solvent in the varnish used in the present invention, water or an organic solvent are used. A resin used may be thoroughly dissolved in water or an organic solvent. In addition, the resin may be in the states partially dispersed in the solvent or so called an emulsion, emulsified in the solvent. The organic solvent used in the present invention is not especially limited. Ketons such as methyl ethyl ketone, aromatic hydrocarbons such as toluene, alcohols such as ethyl alcohol, ethers such as diethyl ether, esters such as methyl acetate, nitrogen-containing solvents such as dimethylformamide, chlorine-containing solvents such as carbon tetrachloride, and the like may be used. These solvents may be used alone or as a mixture of two or more. The amount of water or an organic solvent used is not required to be especially limited because it will be determined according to the required viscosity and resin solid content.

These resins are heated at a specific temperature after coating, the solvent is evaporated and cured. The heating condition is not especially limited, because known suitable conditions for the respective resins can be followed.

The resin varnish described above is used as a thin resin varnish by adjusting a solid content in a certain range with a solvent to make the varnish easily impregnate into a ceramic particle film. That is, the resin varnish is preferable to be a resin varnish having a solid content of 0.1% by weight to 1.0% by weight by dissolving the resin compositions in an organic solvent. By the way, when the solid content is less than 0.1% by weight, the viscosity is too low and it makes it hard to hold an organic component in a ceramic particle film. In contrast, when the solid content exceeds 1.0% by weight, distribution of the impregnated resin varnish amount tends to be deviated. So, when an excessive amount of a resin is impregnated, an excessive resin film is formed on a ceramic particle film because of the too high viscosity. The excessive resin film may sometime makes preparation of a ceramic particle film having a good dielectric performance hard. So, it is not preferable. In addition, it is preferable to impregnate a silane coupling agent solution into a ceramic particle film followed by heating before the resin impregnation as a pre-treatment to improve the wettability of ceramic particles with a resin varnish.

The heat treatment after impregnation of the resin varnish is a treatment for heating a ceramic particle film impregnated with the resin varnish after carrying out drying. More practically, the ceramic particle film impregnated with the resin varnish is heated at a temperature of 170° C. to 230° C., a curing temperature of the resin, to make a resin semi-cure or cure. In such a way, a resin binder is formed. Further as a mean for drying, air drying at room temperature, heating at a temperature of 100° C. to 130° C. and the like can be employed.

In addition, a polyimide resin composition may be applicable. The polyimide resin composition is not especially limited. Polyamic acid copolymers disclosed in Japanese Patent Laid-Open Nos. 5-51453, 5-59173, 5-70590, 5-70591, 2006-117791 and the like can be used. A production method of a polyimide resin composition will be briefly demonstrated. A polyamic acid copolymer as a precursor of a polyimide resin is synthesized in a solution including nearly equimolar amounts of tetracarboxylic dianhydride and diamine as raw materials. A polyimide resin is obtained by making the polyamic acid copolymer cause an imidization reaction.

Organic solvents able to be used for preparation of a resin varnish including the polyimide resin are phenolic solvents, pyrrolidone solvents, amide solvents such as acetamide solvents, oxane solvents such as dioxane and trioxane, ketone solvents such as cyclohexanone, glyme solvents such as methyl diglyme and methyl triglyme. In addition, these organic solvents may be used as a mixture with aromatic hydrocarbon solvents such as benzene and toluene, and aliphatic hydrocarbon solvents such as hexane and decane.

The heat treatment when a polyimide resin composition is used is to dry and heat a ceramic particle film impregnated with the resin varnish. The heating causes imidization of a polyamic acid copolymer. The heating condition of a heat treatment may be at 200° C. or higher, more preferably 300° C. or higher after carrying out drying. This is because a sufficient imidization reaction does not complete with the heating temperature of lower than 200° C. So, it is not preferable. In such a way, a resin binder composed of a polyimide resin is formed. As a mean for drying, air drying at room temperature, heating at a temperature of 100° C. to 130° C. and the like can be employed also.

To impregnate the resin varnish among ceramic particles constituting a ceramic particle film, any method which can bring a ceramic particle film on a metal layer surface into contact with a resin varnish as a result may be used. For example, a method in which a metal layer provided with a ceramic particle film formed thereon is immersed in a resin varnish and a method in which a resin varnish is sprayed on a ceramic particle film on a metal layer surface or the like may be used.

### C: Various Types of Products Using a Laminate Composed of a Ceramic Insulating Layer and a Metal Layer

The laminate composed of a ceramic insulating layer and a metal layer according to the present invention can be widely used in the fields of an electronic device. In practice, the laminate composed of a ceramic insulating layer and a metal layer is suitably used in production of many kind of electronic devices, circuit formation of printed wiring boards, semiconductor circuits and circuits including semiconductor circuits, and capacitors utilizing dielectric performance of the ceramic insulating layer and the like.

### Example 1

In the Example 1, a laminate composed of a ceramic insulating layer and a metal layer of Type I was produced by the following method.

Preparation of a metal layer: As an electrode material (cathode electrode) on which a ceramic particle film is formed, a copper foil (surface roughness Rz of 0.6 μm and Ra of 0.16 μm) produced by an electrolysis method and having an average thickness of 15 μm was prepared. The average thickness of the copper foil disclosed is a gage thickness.
Preparation of a ceramic particle dispersion slurry: The dielectric particle dispersion slurry was prepared by mixing acetone into a suspension in which (Ba_{0.9}Sr_{0.1})TiO₃ particles having an average particle size of about 80 nm and a specific surface area of 18.38 m²/g are dispersed in n-butanol to adjust dielectric particle concentration to be 10 g/l, and the slurry was stirred for 5 minutes with ultrasonic vibration.
Electrophoretic deposition: In the electrophoretic deposition, the copper foil (cathode electrode) on which a ceramic particle film is formed and a stainless steel plate (anode electrode) were arranged with distance of 20 mm in the ceramic particle dispersion slurry. Then, the ceramic particle film of (Ba_{0.9}Sr_{0.1})TiO₃ was formed on the copper foil (cathode electrode) on which a ceramic particle film is provided with loaded voltage of 10 V for 30 second.
Impregnation of a precursor solution: The copper foil provided with a ceramic particle film on the surface was immersed into a precursor solution and was slowly pulled up to impregnate the precursor solution into the ceramic particle film. The precursor solution used was prepared by adjusting concentration to be 0.25% by weight by diluting BS-05S (SiO₂—B₂O₃, the concentration of 5% by weight, 50 g of SiO₂-B₂O₃ can be prepared from 1 L thereof) produced by Kojundo Chemical Laboratory Co., Ltd. with 20 times the BS-05S weight of ethanol.
Heat treatment: Then, drying was carried out at room temperature followed by drying in the air atmosphere at 120° C. for 3 minutes. Next, heating was carried out in a nitrogen atmosphere (an atmosphere in which a saturated steam-containing nitrogen at 25° C. was filled) with a temperature elevation rate of 5° C./minute up to 600° C., and kept at 600° C. for 1 hour, and cooled down to room temperature with a temperature reduction rate of 5° C./minute. Thereafter, the film was kept under the condition where an oxygen concentration was adjusted to be 6 ppm (in the nitrogen carrier gas) at 600° C. for 15 minutes, and then cooled down to room temperature. In such a manner, a ceramic binder was provided among the ceramic particles, and a copper foil with a ceramic insulating layer provided with a ceramic insulating layer having thickness of 1.2 was prepared.
Evaluation of roll winding: The laminate composed of a ceramic insulating layer and a metal layer was wound up using a core tube of 10 cm in diameter. Thereafter, the wound laminate composed of a ceramic insulating layer and a metal layer was unwound. Then, an inspection was carried out on presence of micro-cracks in the laminate composed of a ceramic insulating layer and a metal layer, but no micro-crack generation was observed.

### Example 2

In the Example 2, a laminate composed of a ceramic insulating layer and a metal layer of Type II was produced by the following method. By the way, “the methods for preparation of a metal layer” and “a ceramic particle” was the common steps to those in Example 1. So, just the steps except common steps will be demonstrated.

Electrophoretic deposition: In the electrophoretic deposition, the copper foil (cathode electrode) on which a ceramic particle film is formed and a stainless steel plate (anode electrode) were arranged with distance of 20 mm in the ceramic particle dispersion slurry. Then, the ceramic particle film of (Ba_{0.9}Sr_{0.1})TiO₃ was formed on the copper foil (cathode electrode) on which a ceramic particle film is provided with loaded voltage of 10 V for 20 second.
Heat treatment: Next, heat treatment in a nitrogen atmosphere (an atmosphere in which a saturated steam-containing nitrogen at 25° C. was filled) with a temperature elevation rate of 5° C./minute up to 600° C., and kept at 600° C. for 1 hour, and cooled down to room temperature with a temperature reduction rate of 5° C./minute was carried out.
Preparation of a resin varnish: 100 parts by weight of an epoxy resin (trade name: Epikote 828, produced by Japan Epoxy Resins Co., Ltd.) and 1 part by weight of an imidazole compound (trade name: Curezol 2E4MZ, produced by Shikoku Chemicals Corp.) as an epoxy resin curing agent were mixed to prepare a resin composition. Then, using methyl ethyl ketone (reagent) as a solvent, an epoxy resin varnish with concentration of the epoxy resin and the epoxy resin curing agent in total, i.e. solid content of 0.22% by weight was prepared.
Impregnation of the resin varnish: The epoxy resin varnish prepared was coated on the ceramic particle film of the copper foil provided with the ceramic particle film on the surface by using a spin coater, to impregnate the epoxy resin varnish into the ceramic particle film.
Heat treatment: Next, the resin varnish impregnated ceramic particle film was heated on a hot plate at 150° C. for 2 minutes, to remove a certain amount of the solvent and make the resin varnish semi-cure. Then, the film was heated in an oven at 190° C. for 30 minutes to fully cure the resin. In such a manner, an epoxy resin binder was provided among the particles constituting the ceramic particle film, and a copper foil with a ceramic insulating layer provided with a ceramic insulating layer having thickness of 1.0 μm was prepared.
Evaluation of roll winding: The laminate composed of a ceramic insulating layer and a metal layer was wound up using a core tube of 10 cm in diameter. Thereafter, the wound laminate composed of a ceramic insulating layer and a metal layer was unwound. Then, an inspection was carried out on presence of micro-cracks in the ceramic insulating layer of the laminate composed of a ceramic insulating layer and a metal layer, but no micro-crack generation was observed.

### Comparative Example

In Comparative Example, a copper foil with a ceramic insulating layer which is provided just a ceramic particle film of (Ba_{0.9}Sr_{0.1})TiO₃ on a surface of a copper foil was prepared without carrying out the formation of a binder by omitting the impregnation of a precursor solution after the electrophoretic deposition in the production method of a copper foil with a ceramic insulating layer disclosed in Example 1. Then, insulating performances of the copper foil with a ceramic insulating layer and the laminates composed of a ceramic insulating layer and a metal layer prepared in the Examples were compared.

### <Comparison of Insulating Performance Among the Examples and the Comparative Example>

In comparison of the insulating performances, the degrees of the dielectric loss and the leakage current density at 10-V loading in a ceramic insulating layer were selected as a property to be investigated for judgment of the insulating performance. Dielectric losses and leakage current densities investigated in the Examples and the Comparative Example are shown in the following Table 1 for comparison. In the investigation of the properties of ceramic insulating layers prepared in the Examples and the Comparative Example as a dielectric film, the dielectric performance was investigated after forming an electrode (corresponding to a top electrode of a capacitor circuit) on a surface of the ceramic insulating layer. The electrode was formed as a copper electrode of 0.2 μm in thickness and 1 mm×1 mm in size by sputtering with a metal mask placed on a surface of the ceramic insulating layer.

TABLE 1

| | Dielectric Loss | Leakage Current |
|---|---|---|
| Sample | (tanδ) | Density (A/cm²) |
| Example 1 | 0.02 | 8.4 × 10⁻⁸ |
| Example 2 | 0.02 | 8.2 × 10⁻⁸ |
| Comparative | 0.09 | 2.2 × 10⁻⁷ |
| Example | | |

As is obvious in Table 1, the values of dielectric losses in Example 1 and Example 2 are smaller than that in Comparative Example. Therefore, it is understood that the insulating performance of the Examples are superior to that of the Comparative Example. In addition, the ceramic insulating layer formed in the Example 1 is excellent in high-temperature heat resistance because the ceramic insulating layer is composed of just oxides.

In addition, Table 1 shows a comparison on the leakage current densities among the Examples and the Comparative Example. As is obvious in the table, the leakage current densities of the Example 1 and Example 2 are 8.4×10⁻⁸ A/cm² and 8.2×10⁻⁸ A/cm², and the leakage current density of the Comparative Example is 2.2×10⁻⁷ A/cm². That is, it can be understood that the leakage current densities in the Examples are lower than that of the Comparative Example, i.e. insulating performance of the Examples are excellent.

### INDUSTRIAL APPLICABILITY

The laminate composed of a ceramic insulating layer and a metal layer according to the present invention can provide a broad electric performance to the ceramic insulating layer in response to the applications, by selecting specific materials for “ceramic particles” and “a binder provided among ceramic particles” constituting the ceramic insulating layer. Therefore, the laminate composed of a ceramic insulating layer and a metal layer according to the present invention can be used as a base material for various types of electronic devices, circuit formation of printed wiring boards, semiconductor circuits and circuits including semiconductor circuits, capacitors utilizing dielectric performance of the ceramic insulating layer and the like.

The production methods of laminate composed of a ceramic insulating layer and a metal layer are that a ceramic particle film is formed on the metal layer surface, a precursor solution able to be a ceramic or a resin varnish is impregnated into the ceramic particle film, and then a specific heat treatment is carried out to provide a binder among the ceramic particles and finish an insulating layer. So, the products can be produced in a short time with lower cost.

1. A laminate composed of a ceramic insulating layer and a metal layer which is characterized in that the ceramic insulating layer includes a binder provided among ceramic particles constituting a ceramic particle film formed by electrophoretic deposition of the ceramic particles.

2. The laminate composed of a ceramic insulating layer and a metal layer according to claim 1, wherein the binder is a ceramic binder or a resin binder.

3. The laminate composed of a ceramic insulating layer and a metal layer according to claim 1, wherein the used ceramic particles are particles having an average particle size of 300 nm or less.

4. The laminate composed of a ceramic insulating layer and a metal layer according to claim 1, wherein the used ceramic particles are dielectric particles.

5. The laminate composed of a ceramic insulating layer and a metal layer according to claim 4, wherein the ceramic particles have a perovskite-type structure.

6. The laminate composed of a ceramic insulating layer and a metal layer according to claim 1, thickness of the ceramic insulating layer is 0.1 μm to 5.0 μm.

7. A method for producing a laminate composed of a ceramic insulating layer and a metal layer according to claim 1 which is characterized in that
a ceramic particle film is formed on a surface of a metal layer;
a precursor solution which is able to be a ceramic is impregnated among ceramic particles constituting the ceramic particle film; and
then heat treatment is carried out to convert the impregnated precursor solution into the ceramics to provide a ceramic binder among the ceramic particles to finish an insulating layer.

8. The method for producing a laminate composed of a ceramic insulating layer and a metal layer according to claim 7, wherein
a sol-gel solution able to be a ceramics is used as the precursor solution.

9. The method for producing a laminate composed of a ceramic insulating layer and a metal layer according to claim 7, wherein
in the formation of a ceramic particle film on a surface of the metal layer, electrolysis is carried out in the slurry where a ceramic particle are dispersed by using the metal layer as an electrode to form a ceramic particle film on a surface of the metal layer.

10. A method for producing a laminate composed of a ceramic insulating layer and a metal layer according to claim 1 which is characterized in that
a ceramic particle film is formed on a surface of a metal layer;
a resin varnish is impregnated among ceramic particles constituting the ceramic particle film; and
the resultant ceramic particle film is heat treated to make the impregnated resin varnish semi-cure or cure to provide a resin binder among the ceramic particles to finish an insulating layer.

11. The method for producing a laminate composed of a ceramic insulating layer and a metal layer according to claim 10, wherein
in the formation of a ceramic particle film on a surface of the metal layer, electrolysis is carried out by using the metal layer as an electrode in a slurry where a ceramic particle are dispersed to form a ceramic particle film on a surface of the metal layer.

12. An electronic device which is characterized in obtained by using a laminate composed of a ceramic insulating layer and a metal layer according to claim 1.
